(19) United States
(12) Patent Application Publication
(10) Pub. No.: US 2016/0278381 A1
(43) Pub. Date: Sep. 29, 2016

(54) Agricultural And Horticultural Fungicidal Composition And Method Of Use Of the Same

(71) Applicant: NIHON NOHYAKU CO., LTD., Tokyo (JP)

(72) Inventor: Tsuyoshi TAKEMOTO, Kawachinagano (JP)

(21) Appl. No.: 15/078,349

(22) Filed: Mar. 23, 2016

(30) Foreign Application Priority Data
Mar. 25, 2015 (JP) 2015-062760

(51) Int. Cl. A01N 43/82; A01N 37/34

(52) U.S. Cl. CPC A01N 43/82; A01N 37/34

(57) ABSTRACT

The present invention provides an agricultural and horticultural fungicidal composition comprising tiadinil or a salt thereof and chlorothalonil as active ingredients, which has a wide fungicidal spectrum as well as a synergistic effect between the two active ingredients, in particular, to lawn grass diseases.

### TECHNICAL FIELD

The present invention relates to an agricultural and horticultural fungicidal composition comprising tiadinil or a salt thereof and chlorothalonil and a method of use of the composition, and a method of control of a plant disease using a synergistic effect of the combination, relating, in particular, to a fungicidal composition on lawn grass diseases and a method of use thereof.

### BACKGROUND ART

One of the active ingredients of the present invention, tiadinil, is a known compound, for example, in Patent Documents 1 and 2 below; Patent Document 1 describes the compound and a method of manufacturing the same as well as an agricultural and horticultural fungicidal composition containing the compound. Patent Document 2 describes fungicidal compositions containing a thiadiazole derivative including tiadinil and one or more various compounds having a fungicidal activity and a method of use thereof.

Chlorothalonil is a known compound described in literature: See, for example, Non-Patent Document 1 below.

### CITATION LIST

Patent Document 1 WO99/23084 A
Patent Document 2 EP 0976326 A
Non-Patent Document 1 The Pesticide Manual 16th Edition (British Crop Production Council) (2012)

### SUMMARY OF INVENTION

### Technical Problem

The present invention aims to provide an agricultural and horticultural fungicidal composition having a wide fungicidal spectrum on various plant diseases and an excellent controlling efficacy at a low dose; providing in particular, an agricultural and horticultural fungicidal composition having an excellent controlling efficacy against lawn grass diseases.

### Solution to Problem

The present inventors, having tried to solve the above-mentioned problem, made intensive studies continuously, found out that an agricultural and horticultural fungicidal composition containing tiadinil and chlorothalonil as active ingredients exhibits a synergistic controlling effect, having a wide fungicidal spectrum, and completed the present invention with further studies.

Namely, the present invention relates to:

(1) An agricultural and horticultural fungicidal composition comprising tiadinil or a salt thereof and chlorothalonil as active ingredients.
(2) The agricultural and horticultural fungicidal composition according to Item (1) above, wherein the composition contains, to one part by mass tiadinil or a salt thereof, 0.5 to 1000 parts by mass of chlorothalonil.
(3) A method of use of the agricultural and horticultural fungicidal composition, wherein, using an effective amount of the agricultural and horticultural fungicidal composition according to Item (1) or (2) above, a target plant, seeds of a target plant, soil or a cultivation carrier is treated and a plant disease is controlled.
(4) A method of controlling a plant disease, wherein each of tiadinil and chlorothalonil are treated separately on a plant or cultivation carrier around the same period and the plant disease is controlled.
(5) A combination of tiadinil or a salt thereof and chlorothalonil.
(6) The method of controlling a plant disease according to Item (4) above, wherein the plant disease is a lawn grass disease.
(7) The method of controlling a plant disease according to Item (6) above, wherein the lawn grass disease is Pythium aphanidermatum.

### Effect Achieved by the Invention

The present agricultural and horticultural fungicidal composition has an excellent feature compared with the prior art, in particular, as an agricultural and horticultural fungicidal agent, having a wide controlling spectrum against various plant diseases; the present agricultural and horticultural fungicidal composition is superior to the use of either one of the active ingredients alone, achieving a remarkable efficacy at doses which do not give a sufficient efficacy when used alone, so that the present agricultural and horticultural fungicidal composition has a remarkable controlling efficacy against plant diseases which used not be controlled with either one of the active ingredients alone or those which exhibit drug resistance and the like. The present agricultural and horticultural fungicidal composition, with a low global environmental impact, establishes an effective control of various plant diseases.

### DETAILED DESCRIPTION OF THE INVENTION

A first active ingredient of the present invention, tiadinil (common name) is a known compound as described, for example, in WO99/23084A and can be manufactured according to the method described therein. In addition, commercially available agrochemical formulations can also be used.

A second active ingredient of the present invention, chlorothalonil (common name) as well is a known compound as described, for example, in literature such as The Pesticide Manual In addition; as the chlorothalonil, commercially available agrochemical formulations thereof can be used, and the chlorothalonil can be manufactured according to a known method.

The agricultural and horticultural fungicidal composition according to the present invention has an excellent efficacy against various agricultural and horticultural plant diseases and, in particular, is suitable for controlling lawn grass disease.

The agricultural and horticultural fungicidal composition according to the present invention has an excellent fungicidal efficacy against agricultural and horticultural plant diseases caused by a wide spectrum of fungi belonging, for example to, Oomycetes, Ascomycetes, Deuteromycetes or Basidiomycetes as well as other plant disease bacteria and plant viruses.

The agricultural and horticultural fungicidal composition according to the present invention can be used, for example, the following agricultural and horticultural plant diseases: Examples of rice diseases include: downy mildew (S. macrospora), seedling blight (R. chinensis, T. viride), bakanae disease (G. fujikuroi), rice blast (M. grisea, P. oryzae), sheath blight (R. solani), brown spot (C. miyabeanus), browning ear (A. padwiki), pink coloring of rice grains (E. nigrum), false smut (C. virens), glume blight (P. glumae), sheath brown rot disease (P. fuscovaginae), bacterial brown stripe (P. avenae), bacterial seedling blight (P. plantarii), and bacterial leaf blight (X. oryzae);

Examples of corn diseases include: leaf spot (B. maydis, C. heterostrophus), leaf bright (E. turcicum), brown spot (P. maydis), and smut (U. maydis), and examples of tobacco diseases include: black shank (P. nicotianae/parasitica), downy mildew (P. tabacina), powdery mildew (E. cichoracearum), anthracnose (C. tabaum), brown spot (A. longipes, A. alternata), sooty mold (C. salicinum), and olpidium seedling blight (O. brassicae);

Examples of tea diseases include: coral spot disease (N. cinnabarina), white scab (E. leucospila), anthracnose (C. theae-sinensis), gray blight (P. longiseta, P. theae), net blister blight (E. reticulatum), blister blight (E. vexans), and bacterial shoot blight (P. syringae pv. theae); examples of food crop diseases include: sweet potato black rot (C. fimbriata), sweet potato blue mold (P. expansum), sweet potato root rot (T. basicora), oat crown rust (P. coronata), mulberry branch blight (S. mori), oil palm ganoderma disease (G. boninense), and date palm eyespot (S. palmivora); examples of diseases of the Cruciferae family include: clubroot (P. brassicae), white rust (A. macrospora), downy mildew (P. brassicae), and stem rot (S. scloerotiorum); cabbage black leg (P. lingam), cabbage head rot (T. cucumeris), rapeseed white spot (C. brassicicola), Chinese cabbage white spot (C. brassicicola), leaf spot of the Cruciferae family (A. brassicae), and cabbage black rot (X. campestris pv. campestris);

Examples of strawberry diseases include: Phytophthora rot (P. cactorum, P. nicotianae), powdery mildew (S. macularis), anthracnose (G. cingulata), black leaf spot (A. alternata), and leaf spot (M. fragariae); examples of tomato diseases include: late blight (P. infestans), anthracnose (C. phomoides), leaf mold (C. fulvum), leaf spot (S. lycopersici), early blight (A. solani), and ulceration (C. michiganensis); examples of diseases of the Solanaceae family include: stem rot (S. sclerotiorum), powdery mildew (S. furiginea), brown spot (P. vexans), leaf mold (M. nattrassii), sweet pepper frogeye leaf spot (S. lycopersici), red pepper frogeye leaf spot (S. lycopersici), solanaceous bacterial wilt (P. solanacearum), and solanaceous bacterial wilt (P. solanacearum);

Examples of diseases of the Cucurbitaceae family include: Phytophthora disease of cucurbitaceae plants (P. melonis), cucumber downy mildew (P. cubensis), cucumber powdery mildew (S. furiginea), cucumber gummy stem blight (M. melonis, D. bryoniae), watermelon gummy stem blight (M. melonis, D. bryoniae), cucumber stem rot (S. sclerotiorum), cucumber anthracnose (C. lagenarium), cucumber corynespora leaf spot (C. cassiicora), cucumber scab (C. cucumerinum), fusarium wilt of cucurbitaceae plants (F. oxysporum f. sp. cucumerinum, F. oxysporum f. sp. meronis), and cucumber bacterial spot (P. syringae pv. Lachrymans); examples of green onion/onion diseases include: green onion downy mildew (P. destructor), onion leaf spot (P. herbarum), onion watery soft rot (S. sclerotiorum), onion gray-mold neck rot (B. alli), onion Botrytis leaf blight (B. byssoidea, B. squamosa), green onion Alternaria leaf spot (A. porri), onion Fusarium basal rot (F. oxysporum f. sp. cepae), and green onion rust (P. allii);

Examples of diseases of root crops include: carrot leaf blight (A. dauci), and Japanese white radish Alternaria leaf spot (A. brassicicola); examples of diseases of flowing plants include: rose Phytophthora disease (P. megasperma), rose powdery mildew (S. pannosa), rose rust (K. rosae/japonica), rose black spot (D. rosae), chrysanthemum leaf blight (S. chrysanthemi-indici), chrysanthemum leaf spot (C. chrysanthemi), chrysanthemum rust (P. horiana), lettuce downy mildew (B. lactucae), aster downy mildew (B. lactucae), and crown gall (A. tumefaciens);

Examples of lawn grass diseases include: pythium red blight (Pythium aphanidermatum), red thread (Laetisaria fuciformis), winter patch (yellow patch, elephant's foot (Ceratobasidium graminuem), summer patch (Magnaporthe.poae), rust (Puccinia Zoysiae, Puccinia sp.), take-all patch (Gaeumannomyces graminis var. avenae), leaf spot (Bipolaris (Cochliobolus) sp.), solvent loss disease (melting out (Drechslera.poae)), dollar spot (Sclerotinia.homoeocarpa), anthracnose (Colletotrichum.graminicora), curvularia leaf spot (Curvularia.geniculata), nectrotic ring spot (Ophiosphaerella korrae), white blight (Melanotus phillipsii), bacterial blight (Trechispora coherens, Coprinus kubickae), large patch (Rhizoctonia.solani), brown patch (Rhizoctonia.solani), snow mold (Pythium sp., S. borealis, Microdochium. nivale, F. nivale), typhula snow blight (Typhula incarnata, Typhula ishikariensis) and the like;

Examples of pasture plant diseases include: tar spot of grasses (P. graminis), alfalfa leaf spot (P. medicaginis), clover leaf spot (P. trifolii), grass choke (E. typhina), alfalfa yellow leaf blotch (P. medicaginis), and alfalfa spring black stem (P. medicaginis);

Examples of wheat diseases include: snow blight (Pythium sp., M. nivalis, S. borealis, F. nivale), snow blight (T. ishikariensis, T. incarnata), scab (G. zeae, F. avenaceum, F. graminearum, F. culmorum, M. nivale), ergot (C. purpurea), take-all (G. graminis), foot-rot (C. gramineum), sharp eyespot (C. cereale), powdery mildew (B. graminis fsp. Tritici), glume blotch (L. nodorum, S. nodorum), leaf rust (P. recondita), stem rust (P. graminis), stripe rust (P. striiformis), eye spot (P. herpotrichoides), speckled leaf blotch (S. tritici), yellow spot (P. tritici-repentis), Cephalosporium stripe (C. gramineum), loose smut (U. nuda), stinking smut (T. caries), and flag smut (U. agropyri);

Examples of barley diseases include: snow mold (Pythium sp., S. borealis, M. nivalis, F. nivale, T. ishikariensis, T. incarnata), scab (G. zeae, M. nivale, F. avenaceum, F. graminearum, F. culmorum), ergot (C. purpurea), take-all (G. graminis, O. graminis), Cephalosporium stripe (C. gramineum), powdery mildew (B. graminis fsp. Hordei), net blotch (P. teres), stripe (P. graminea), spot blotch (B. sorokiniana C. sativus), leaf scorch (C. herbarm), leaf blotch (R. secaris), stem rust (P. graminis), stripe rust (P. striiformis), dwarf leaf rust (P. hordei), and covered smut (U. hordei);

Examples of potato diseases include: powdery scab (S. subterranea), scab (S. scabies), late blight (P. infestans), early blight (A. solani), black scurf (R. solani), ring rot (C. michiganensis) and ring rot (C. michiganensis); and examples of sugar beet diseases include: Aphanomyces root rot (A. sochlioides), leaf blight (T. cucumeris), root rot (T. cucumeris), Phoma root rot (P. betae), Cercospora leaf spot (C. beticora), Ramularia leaf spot (R. beticora), and rust (U. betae);

Examples of diseases of beans include: Sclerotinia rot (S. sclerotiorum), soybean rust (P. pachyrhizi), soybean powdery mildew (P. manchurica), soybean purple stain (C. kikuchii), soybean pod and stem blight (D. phaseolorum var. sojae), soybean Sphaceloma scab (E. glycines), soybean charcoal rot (M. phaseolina), soybean root necrosis (C. crotalariae), peanut peg, pod and root necrosis (C. crotalariae), peanut leaf spot (M. personatum), peanut scab (S. arachidis), peanut crown rot (A. niger), peanut brown leaf spot (C. arachidicola), green bean leaf spot (C. arachidicola), green bean anthracnose (C. indemthianum), green bean root rot (F. solani f. sp. phaseoli), green bean bacterial wilt (C. flaccumfasiens), azuki bean angular leaf spot (P. griseola), pea downy mildew (P. pisi), pea powdery mildew (E. pisi), broad bean Phytophthora rot (P. nicotianae), broad bean downy mildew (P. viciae), and broad bean brown spot (A. fabae);

Examples of apple diseases include: powdery mildew (P. leucotricha), Valsa canker (V. ceratosperma), white root rot (R. necatrix), violet root rot (H. mompa), scab (V. inaequaris), Alternaria blotch (A. mali), Monilia leaf blight (M. mali), bitter rot (G. cingulata), ring rot (Botryosphaeria sp.), black rot (B. obtusa, X. campestris pv. campestris), fruit spot (M. pomi), blotch (D. mali), rust (G. yamadae), cedar-apple rust (G. Juniperi-virginianae), Schizophyllum rot (S. commune), silver leaf (C. purpurreum), crown gall (A. tumefaciens), and fire blight (E. amylovora);

Examples of Nashi pear diseases include: white root rot (R. necatrix), scab (V. nashicola), black spot (A. kikuchiana), rust (G. asiaticum), powdery mildew (P. pyri), ring rot (P. piricora), Phonopsis canker (P. fukushii), stem heart rot (L. sulphureus), crown gall (A. tumefaciens), and fire blight (E. amylovora); and examples of grape diseases include: white root rot (R. necatrix), gray mold (B. cinerea), downy mildew (P. viticola), powdery mildew (U. necator), ripe rot (G. cingulata), anthracnose (E. ampelina), leaf blight (P. vitis), rust (P. ampelopsidis), black rot (G. bidwellii, X. campestris pv. campestris), Pestalotia gummy stem blight (P. menezesiana), black measles (X. fastidiosa), and crown gall (A. vitis);

Examples of peach diseases include: leaf curl (T. deformans), brown rot (M. fructicola), scab (C. carpophilum), Phomopsis rot (Phomopsis sp.), Aspergillus rot (A. niger), leaf spot (C. beyerinckii), crown gall (A. tumefaciens), and bacterial shot hole (X. campestris pv. pruni); examples of citrus diseases include: white root rot (R. necatrix), gray mold (B. cinerea), melanose (D. citri), scab (E. fawcettii), black spot (G. citricarpa), Phyllosticta leaf spot (P. beltranii), anthracnose (C. gloeosporioides), green mold (P. digitatum), blue mold (P. italicum), stem heart rot (G. applanatum), sooty mold (C. salicinum), canker (X. campestris pv. citri), stubborn disease (S. citri), and Citrus huanglongbing HLB (C. Liberibacter);

Examples of diseases of trees/flowering trees include: akebi powdery mildew (M. akebias), powdery mildew of Japanese alders (M. penicillata), Dutch elm disease of elms (O. ulmi), chestnut Endothia canker (E. parasitica), apricot Cytospora canker (L. persoonii), circular leaf spot of elms (G. ulmi), black knot of cherries (A. morbosa), needle cast of pines (L. pinastri), needle cast (R. kalkhoffii), needle blight (R. kalkhoffii), Diplodia blight of pines (S. sapinea), rust of cherries (T. asiatica/prumi-spinosae), leaf rust of willows (M. arctica), leaf rust of poplars (M. medusae), peony rust (C. flaccidum), stem sap rot of oaks (S. hirsutum), cypress butt rot (H. annosum), pine butt rot (G. lucidum), Armillaria root rot (A. mellea), stem sap rot (T. versicolor), gall rust of pines (C. quercum), needle rust of pines (C. asterum), stem heart rot of walnuts (P. igniarius), Japanese red pine Dothistroma needle blight (D. septosporum), Japanese black pine Dothistroma needle blight (D. septosporum), and stem heart rot of cherries (F. pinicora);

Examples of diseases of other fruit trees include: white root rot (R. necatrix), ume tree powdery mildew (P. tridactyla), ume tree scab (C. carpophilum), Japanese persimmon circular leaf spot (M. nawae), Japanese persimmon anthracnose (G. kaki), Japanese persimmon Pestalotia leaf spot (P. diospyri), Japanese persimmon angular leaf spot (C. kaki), Japanese persimmon black spot (F. levieri), loquat anthracnose (C. acutatum), banana leaf spot (M. fijiensis/musicola), banana wilt (F. oxysporum f. sp. cubense), crown gall (A. tumefaciens), and mango anthracnose (C. gloeosporioides);

Examples of polyxeny diseases include: various types of dumping off (P. ultimum, P. aphanidermatum), various types of root rot (P. cinnamomi), white root rot (R. necatrix), canker (V. ceratosperma), Verticillium wilt (V. dahliae, V. albo-atrum), gray mold (B. cinerea), stem rot (S. sclerotiorum), southern blight (S. rolfsii), wilt of vegetables (R. solani), violet root rot (H. mompa), bacterial soft rot (E. carotovora, E. aroideae), and crown gall (A. tumefaciens).

The present invention can be appiled, in particular, for lawn grass diseases.

Besides, the fungicide of the present invention has an excellent bactericidal effect on resistant bacteria. Examples of the resistant bacteria include Botrytis cinerea, Cercospora beticola of sugar beet, Venturia inaequalis of apple, and Venturia nashicola of Nashi pear that show resistance to a benzimidazole fungicide such as thiophanate methyl, benomyl or carbendazim; and Botrytis cinerea showing resistance to a dicarboximide fungicide (such as vinclozolin, procymidone or iprodione).

Examples of plant pathologenic bacterial diseases include: cucumber bacterial spot (P. syringae pv. Lachrymans), rice bacterial brown stripe (P. avenae), rice bacterial seedling blight (P. plantarii), rice glume blight (P. glumae), rice sheath brown rot disease (P. fuscovaginae), solanaceous bacterial wilt (P. solanacearum), tea bacterial shoot blight (P. syringae pv. theae), citrus canker (X. campestris pv. citri), cabbage black rot (X. campestris pv. campestris), peach bacterial shot hole (X. campestris pv. pruni), rice bacterial leaf blight (X. oryzae), grape black rot (X. campestris pv. campestris), apple black rot (X. campestris pv. campestris), apple fire blight (E. amylovora), Nashi pear fire blight (E. amylovora), bacterial soft rot (E. aroideae, E. carotovora), green bean bacterial wilt (C. flaccumfasiens), crown gall (A. tumefaciens), grape crown gall (A. vitis), potato scab (S. scabies), citrus stubborn disease (S. citri), tomato ulceration (C. michiganensis), potato ring rot (C. michiganensis), ring rot (C. michiganensis), and Citrus huanglongbing HLB (C. Liberibacter);

Examples of diseases caused by plant viruses include: tomato mosaic disease (tobacco mosaic virus), cucumber green mottle mosaic disease (cucumber green mottle mosaic virus), tobacco rattle (tobacco rattle virus), wheat dwarf disease (wheat dwarf virus), barley stripe mosaic disease (wheat stripe mosaic virus), potato spraing (potato mop-top virus), sweet beet rhizomania (beet necrotic yellow vein virus), tomato mosaic disease (potato virus X), apple topworking disease (apple stem grooving virus), apple topworking disease (apple chlorotic leaf spot virus), tomato mosaic disease (potato virus Y), Japanese apricot pox disease (plum pox virus), cucumber mosaic disease (zucchini yellow mosaic virus), Japanese white radish mosaic disease (turnip mosaic virus), soybean mosaic disease (soybean mosaic virus), barley yellow mosaic disease (barley yellow mosaic virus), barley yellow dwarf disease (barley yellow dwarf virus), soybean dwarf disease (soybean dwarf virus), strawberry virus disease (strawberry mild yellow edge virus), potato leafroll disease (potato leafroll virus), rice dwarf disease (rice dwarf virus), cucumber mosaic disease (cucumber mosaic virus), alfalfa mosaic disease (alfalfa mosaic virus), mosaic disease (northern cereal mosaic virus), rice stripe disease (rice stripe virus), tomato spotted wilt (tomato spotted wilt virus), rice dwarf disease (rice dwarf virus), and rice black-streaked dwarf disease (rice black streaked dwarf virus), and the present inventive composition shows an excellent controlling efficacy, in particular, against rice stripe disease (rice stripe virus);

The useful plants for which the agricultural and horticultural fungicidal composition of the present invention can be used are not particularly limited, and examples of the useful plants include: cereals (such as rice, barley, wheat, rye, oat, and corn); beans and peas (such as soybeans, red beans, broad beans, peas, kidney-beans and peanuts); fruit trees and fruits (such as apples, citruses, Nashi pears, grapes, peaches, Japanese apricots, cherries, walnuts, chestnuts, almonds and bananas); leafy and fruit vegetables (such as cabbages, tomatoes, spinaches, broccolis, lettuces, onions, green onions, Spanish paprikas, eggplants, strawberries, peppers and okras); root crops (such as carrots, potatoes, sweet potatoes, taros, Japanese white radishes, turnips, lotus roots, burdocks, and garlics); processing crops (such as cotton, flax, beet, hop, sugarcane, sugar beet, olive, gum, coffee, tobacco, and tea); cucurbitaceous plants (such as pumpkins, cucumbers, water melons, oriental melons, and melons); pasture plants (such as orchard grass, sorghum, timothy, clover, and alfalfa); lawn grasses; perfumery ornamented crops (such as lavenders, rosemaries, thymes, parsleys, peppers, and gingers); flowering plants (such as chrysanthemums, roses, carnations, and orchids).

The present invention is, in particular, applied to lawn grasses and can be carried out for any lawn grasses including cool-season and warm-season lawn grassses.

Examples of the cool-season lawn grasses are as follows: blue grasses (Poa spp.)) such as, for example, Kentucky bluegrass (Poa pratensis L), rough bluegrass (Poa trivialis L.), Canadian bluegrass (Poa compressa L.), annual bluegrass (Poa annua L.), upland bluegrass (Poa glaucantha Gaudin), wood meadow grass (Poa nemoralis L.), and bulbous bluegrass (Poa bulbosa L.); bentgrasses and redtop grass (Agrostis spp.)), such as, for example, creeping bentgrass (Agrostis palustris Huds.), common bent (Agrostis tenuis Sibth.), velvet bentgrass (Agrostis canina L.), South German Mixed Bentgrass (Agrostis spp.), this including common bent (Agrostis tenuis Sibth.), velvet bentgrass (Agrostis canina L.) and creeping bentgrass (Agrostis palustris Huds.), and bent (Agrostis alba L.); fescues ((Festucu spp.) such as, for example, red fescue (Festuca rubra L. spp. rubra), creeping fescue (Festuca rubra L.), chewings fescue (Festuca rubra commutata Gaud.), Festuca ovina L., hard fescue (Festuca longifolia Thuill.), hair fescue (Festucu capillata Lam.), fescue grass (Festuca arundinacea Schreb.), meadow fescue (Festuca elanor L.); ryegrasses (Lolium spp.), such as, for example, annual ryegrass (Lolium multiflorum Lam.), cockle (Lolium perenne L.), and Italian ryegrass (Lolium multiflorum Lam.); and wheatgrasses (Agropyron spp.)) such as, for example, fairway wheatgrass (Agropyron cristatum(L.) Gaertn.), crested wheatgrass (Agropyron desertorum(Fisch.) Schult.), and western wheatgrass (Agropyron smithii Rydb.). As additional examples of the cold-season lawn grasses, the following can be recited: (beachgrass)(Ammophila breviligulata Fern.), hungarian brome grass (Bromus inermis Leyss.), cattails, such as, for example, timothy (Phleum pratense L.), sand cattail (Phleum subulatum L.), orchard grass (Dactylis glomerata L.), weeping Alkaligrass (Puccinellia distans(L.) Parl.), and crested dog's-tail (Cynosurus cristatus L.).

As examples of the warm-season lawn grasses, the following can be cited: bermuda grass (Cynodon spp. L. C. Rich), zoysiagrass (Zoysia spp. Willd.), St. Augustine grass (St. Augustinegrass, Stenotaphrum secundatum Walt Kuntze), Centipedegrass (Eremochloa ophiuroides Munro Hack.), carpet grass (Axonopus affinis Chase), bahiagrass (Paspalum notatum Flugge), kikuyu grass (Pennisetum clandestinum Hochst. ex Chiov.), buffalo grass (Buchloe dactyloids (Nutt.) Engelm.), (Blue gramma) (Bouteloua gracilis (H.B.K.) Lag. ex Griffiths), biscuit grass (Paspalum vaginatum Swartz), and Sideoats grama)(Bouteloua curtipendula (Michx. Torr.).

Also, the agricultural and horticultural fungicidal composition of the present invention can find practical application in the IPM (which stands for “integrated pest management”). IPM includes, for example, introduction of genetically-modified crop (for example, herbicide-resistant crop, pest-resistant crop having been transfected with the gene encoding an insecticidal protein, disease resistant crop having been transfected with the gene encoding a substance capable of inducing resistance to the disease, taste-improving crop, longer-preservable crop producing plants, yield-improved crop, etc.), utilization of pheromone formulations, such as insect-pheromones (for example, communication disturbing agents among moths), practical utilization of natural-enemy insects, etc., practical utilization of chemical-based agrochemicals, and the like. IPM is a measure, combining these means, to control noxious organisms in an integrated manner. The present inventive agricultural and horticultural fungicidal composition can practically be utilized as the aforementioned agrochemicals.

The present inventive agricultural and horticultural composition can be used as it is without adding other ingredients to the active ingredients; in general, preferable use is achieved by having the composition formulated into a form which is convenient in use by the standard method for formulating agrochemicals.

Namely, tiadinil or a salt thereof and chlorothalonil can be used after having been blended with a proper inert carrier, or optionally together with an adjuvant, in a proper proportion and prepared into a suitable formulation such as suspension, emulsifiable concentrate, soluble concentrate, wettable powder, water dispersible granules, granules, dust tablets or packs through dissolution, separation, suspension, mixing, impregnation, adsorption or sticking.

The inert carrier which can be used in the present invention may be either solid or liquid ones. The material which may be able to serve a useful purpose as a solid carrier includes, for example, soybean meal, cereal meal, wood meal, bark meal, sawdust, tobacco stalk meal, walnut shell meal, wheat bran, cellulose powder, residue after extraction of plant extracts, synthetic polymers such as crushed synthetic polymers, inorganic mineral powders, such as clays (for example, kaolin, bentonite, acid clay, etc.), talcs (for example, talc, pyrrophilite, etc.), silicas (for example, diatomaceous earth, silica sand, mica, white carbon (finely-powdered water-containing silicon, or finely dispersed synthetic silicic acids which, being also referred to as water-containing silicic acid, in some instances consist mainly of calcium silicate), activated carbon, sulfur-powder, pumice, burnt diatomaceous earth, crushed brick, flyash, sand, calcium carbonate, calcium phosphate, etc., plastic carriers, such as polyethylene, polypropylene, polyvinylidene chloride, etc., chemical fertilizers, such as ammonium sulfate, ammonium phosphate, ammonium nitrate, urea, ammonium chloride, etc., compost, and the like. These can be used singly or as a mixture of not less than two thereof.

The material, which can act as a liquid carrier, includes those possessing the solvent capacity and in addition, is selected from materials which eventually get able to disperse the active ingredients by the aid of adjuvants, although they lack in solvent capacity: Its representatives can be exemplified by the below-enumerated carriers, which are used singly or as a mixture of not less than two thereof, and there can be mentioned, for example, water, alcohols (for example, methanol, ethanol, isopropanol, butanol, ethylene glycol, etc.), ketones (for example, acetone, methyl ethyl ketone, methyl isobutyl ketone, diisobutyl ketone, cyclohexanone, etc.), ethers (for example, ethyl ether, dioxane, cellosolve, dipropyl ether, tetrahydrofuran, etc.), aliphatic hydrocarbons (for example, kerosene, mineral oil, etc.), aromatic hydrocarbons (for example, benzene, toluene, xylene, solvent naphtha, alkylnaphthalene, etc.), halogenated hydrocarbons (for example, dichloroethane, chloroform, carbon tetrachloride, chlorinated benzenes, etc.), esters (for example, ethyl acetate, diisopropyl phthalate, dibutyl phthalate, dioctyl phthalate, etc.), amides (for example, dimethylformamide, dimethylformamide, dimethylacetamide, etc.), nitriles (for example, acetonitrile, etc.), dimethyl sulfoxide, and the like.

As the adjuvant, there can be mentioned, for example, the below-exemplified surfactants, dispersion stabilizers, tackiness and/or binding adjuvants, flowability improvers, deflocculating agents, antifoaming agents, preservatives, and the like, and these can be suitably used according to the intended object. The adjuvants may be used singly and may in some instances be employed in combination of not less than two thereof, while none of them in some cases needs be used.

The surfactant can be used, for example, for the purposes of emulsification, dispersion, solubilization and/or wetting of the active ingredients, and can be exemplified by polyoxyethylene alkylene ethers, polyoxyethylene polyalkylaryl ethers, polyoxyethylene higher fatty acid esters, polyoxyethylene resin acid esters, polyoxyethylene sorbitan monolaurate, polyoxyethylene sorbitan monooleate, alkylarylsulfonates, naphthalenesulfonate condensates, ligninsulfonates, higher alcohol sulfuric acid esters, and the like.

The dispersion stabilizer and tackiness and/or binding adjuvant can be used for the purpose of stabilization of dispersion of the active ingredients and also as a tackiness and/or binding adjuvant for the formation of particles. And as such dispersion stabilizer and tackiness and/or binding adjuvant, there can be mentioned, for example, casein, gelatin, starch, methylcellulose, carboxymethylcellulose, gum arabic, polyvinyl alcohols, pine root oil, rice bran oil, bentonite, ligninsulfonates, and the like.

The flowability improver can be used for improvement of the flowability of solid agrochemical forms. As the flowability improver, there can be mentioned, for example, wax, stearic acid salts, alkyl phosphates, and the like. The deflocculating agent can be used as a dispersing-deflocculating agent for suspended formulation forms. And as the deflocculating agent, there can be mentioned, for example, naphthalenesulfonate condensates, condensed phosphoric acid salts, and the like.

The antifoaming agent includes, for example, silicone oils, and the like.

The preservative includes, for example, 1,2-benzoisothiazoline-3-on, p-chloro-meta-xylenol, butyl p-oxybenzoate, and the like.

Furthermore, the agricultural and horticultural fungicidal composition can be incorporated, as the case may be, with functional spreaders, activity-reinforcing agents, such as metabolic-breakdown inhibitors, for example, piperonyl butoxide, etc., antifreezing agents, such as propylene glycol, etc., antioxidants, such as BHT (dibutylhydroxyltoluene), etc., UV absorbers, miscellaneous additives, and the like.

Amounts of fungicidal compounds other than the active ingredients, tiadinil or a salt thereof and chlorothalonil, contained in the present agricultural and horticultural fungicidal composition can be chosen for use from the range of about 0.01 to 90 parts by mass in the 100 parts by mass of the agricultural and horticultural fungicidal composition; in cases, for example, of formulations used in the agricultural and horticultural field, i.e. emulsifiable concentrates, dusts, wettable powders, granules, water dispersible granules, flowables etc., about 0.01 to 50 parts by mass is appropriate. The range of about 1 to 50 parts by mass or so is preferable from an economical viewpoint. As the contents, to 1 mass part of tiadinil or a salt thereof chlorothalonil is, in general, blended in a range of about 0.01 to 1,000 parts by mass, preferably, for expanding the fungicidal spectrum or establish a synergic effect, in a range of about 0.05 to 100 parts by mass, more preferably in a range of about 0.1 to 100 parts by mass, and further more preferably in a range of about 0.1 to 10 parts by mass.

By using the present inventive agricultural and horticultural fungicidal composition to target plants, seeds of a target plants, soil or cultivation carriers, crops can be protected from plant diseases. The present inventive agricultural and horticultural fungicidal composition is used, in an effective amount thereof, by being treated onto target plants, seeds of a target plants, soil or cultivation carriers. To “treat” of the agricultural and horticultural fungicidal composition to target plants, seeds of a target plants, soil or cultivation carriers includes spraying, spreading, spraying or drenching the soil where the target plant is growing and the like.

More specifically, the composition is, for example, directly used or used in the form of a dilution or a suspension properly obtained by using water or the like, and is applied to plants, in which occurrence of pests is anticipated, at a dose effective for controlling the pests; against diseases occurring on fruit trees, cereals and vegetables, the composition may be sprayed onto foliage, or used for seed treatments such as immersion of seeds in an agent solution, seed coating, and a calper treatment, or for absorption from roots by a soil treatment or the like, such as incorporation into the whole soil layer, a row treatment, soil incorporation, a cell seedling treatment, a prickling-in-hole treatment, a plant foot treatment, top dressing, nursery box application for rice, and submerged application. In addition, the agricultural and horticultural fungicidal composition of the present invention can be used for a nutrient solution in solution (water) culture, fumigation, and injection into tree stalks and the like.

As methods for spraying onto foliage of plants, recited are, spraying a liquid formulation such as an emulsifiable concentrate or a flowable, or a solid formulation such as a wettable powder or a water dispersible granule properly diluted with water, spraying a dust, or fumigation.

Examples of the method of treating seeds are: dipping seeds in a diluted or undiluted liquid form of a liquid or solid formulation for making an agent permeate into the seeds; mixing a solid or liquid formulation with seeds for the sake of powder coating to cause the formulation to adhere to the seed surfaces; mixing the preparation with an adhesive carrier such as a resin or a polymer for coating seeds with such an adhesive mixture; and spraying the preparation to the neighborhood of seeds simultaneously with seeding.

Examples of the methods of spraying onto soil or a cultivation support are: Examples of the method of soil or cultivation carrier application include applying a liquid formulation either diluted with water or undiluted onto plant feet, a nursery bed for raising seedlings or the like, spraying a granule onto plant feet, a nursery bed for raising seedling or the like, spraying a dust, a wettable powder, a wettable granule or a granule onto a soil to be mixed with the whole soil either before seeding or before transplantation, spraying a dust, a wettable powder, a water dispersible granule, a granule or the like onto planting holes, planting rows or the like before seeding or before planting plant bodies. A “soil” or “cultivation carrier” means a support for the cultivation of a crop, in particular, a support in which roots grow. The material is not especially limited, and any material can be used as long as a plant can grow therein. For example, so-called soils, a nursery mat, water or the like can be used, and specific examples of the material include sand, pumice, vermiculite, diatomite, agar, gelatinous materials, polymeric materials, rock wool, glass wool, wood chips, barks, paper and the like.

In the method for applying the composition to a nursery box of paddy field rice, the type of formulation may be varied depending on the time of application such as application at the sowing period, the greening period or the transplanting period, and the composition may be applied in the form of a dust, a water dispersible granule, a granule or the like. It can be also applied by mixing with a culture soil. A dust, a water dispersible granule, a granule or the like can be mixed with a soil, for example, mixed with a bed soil, a covering soil or a whole culture soil. Alternatively, the application can be performed by merely making alternate layers of a culture soil and any of various formulations.

For applying the composition to a paddy field, a solid formulation such as a jumbo formulation, a pack formulation, a granule or a water dispersible granule, or a liquid formulation such as a flowable or an emulsifiable concentrate is sprayed usually to a paddy field in a submerged state. Otherwise, a proper formulation itself or a mixture with a fertilizer can be sprayed or injected to a soil at the time of transplantation. Alternatively, the application can be performed in a labor-saving manner in accordance with water supply by using a liquid agent in the form of an emulsifiable concentrate, a flowable or the like at a paddy water inlet or an inlet of water from an irrigation device or the like to a paddy field.

In case of upland field crops, the composition can be applied to a cultivation carrier or the like brought close to seeds or plant bodies in a period from seeding to seedling raising. With respect to plants directly sown in a field, direct application to the seeds as well as application to feet of the plants under cultivation can be suitably performed. A granule may be used for a spraying treatment, or an agent diluted in water or undiluted may be irrigated in the form of a liquid. It is also preferable to mix a granule with a cultivation carrier before seeding and then to seed the crops.

In the case where cultured plants to be transplanted are treated at the seeding time or in the seedling raising period, not only a direct seed treatment but also an irrigating treatment with a liquid agent onto a nursery bed for seedling raising or a granule spraying treatment is preferably performed. Besides, it is also preferable to apply a granule to planting holes at the time of set-planting or to mix it with a cultivation carrier in the neighborhood of a transplantation site.

The agricultural and horticultural fungicidal composition of the present invention may be prepared, for use, into a general formulation, such as an emulsifiable concentrate, a wettable powder, a water dispersible granule, a flowable, a liquid, a granule, a dust or a fumigant. The application dose varies depending on the ratio of the active ingredients, meteorological conditions, the type of formulation, the application time, the application method, the application site, pests to be controlled, a target crop and the like, and is generally appropriately selected from a range of about 0.1 g to 1000 g, preferably about 1 g to 500 g per are in terms of the active ingredients. In the seed treatment, the composition can be used, based on the weight of the seeds, of about 0.001 g to 50 g, preferably about 0.005 g to 10 g per 100 g of seeds in terms of the active ingredients. If an emulsifiable concentrate, a wettable powder or the like is diluted with water or the like for use, an application concentration is 0.00001 to 1%, and a granule, a dust, a liquid used for treating seeds, or the like may be generally directly applied without dilution.

In addition, the active ingredients of the present inventive agricultural and horticultural fungicidal composition, tiadinil or a salt thereof and chlorothalonil, can achieve, by each alone being used separately around the same period, expansion of the fungicidal spectrum equivalent to that of an agricultural and horticultural fungicidal composition in which the active ingredients have been mixed in advance, or a synergistic effect achieved by tiadinil or a salt thereof and chlorothalonil. Namely, formulations of tiadinil or a salt thereof and chlorothalonil, which formulations have separately been prepared, or a diluted solution thereof, may be blended on the site where they are used for the application; furthermore, these formulations can be used around the same period for treating foliage or seeds of plants or cultivation carriers and the like for the treating. When each alone being applied separately, the active ingredients may be applied simultaneously or with an interval of about seven days; preference is given for a case where, during the time when either one of the active ingredients is remaining on the plants or cultivation carriers, the other active ingredient is applied. In the present description, as stated above, the wording “around the same period” includes, in the scope of its meaning, the periods when each one of the active ingredients remains at least partly overlap with each other, being not necessarily just simultaneous. Such a method of controlling a plant disease, where tiadinil or a salt thereof and chlorothalonil are used is one of the present inventions; in the method, each of tiadinil and chlorothalonil are treated separately on a plant or cultivation carrier around the same period and the plant disease is controlled. Effective amounts of tiadinil or a salt thereof and chlorothalonil are equivalent to those above recited for the agricultural and horticultural fungicidal composition.

The present inventive agricultural and horticultural fungicidal composition can further be used, for expanding the fungicidal or insecticidal spectrum of target disease and pests or proper control periods, or to reduce the dose, with one or more other agricultural and horticultural fungicidal agents, an insecticide, acaricide, nematicide, biological agrochemical and the like; in addition, the present inventive agricultural and horticultural fungicidal composition can be used, if suitable for use, as a mixture with a herbicide, plant growth regulator, fertilizer, synergist, safner and the like.

As other agricultural and horticultural fungicidal agents, the following examples can be recited: aureofungin, azaconazole, azithiram, acypetacs, acibenzolar, acibenzolar-S-methyl, azoxystrobin, anilazine, amisulbrom, ampropylfos, ametoctradin, allyl alcohol, aldimorph, amobam, isotianil, isovaledione, isopyrazam, isoprothiolane, ipconazole, iprodione, iprovalicarb, iprobenfos, imazalil, iminoctadine, iminoctadine-albesilate, iminoctadine-triacetate,

imibenconazole, uniconazole, uniconazole-P, echlomezole, edifenphos, etaconazole, ethaboxam, etridiazole, ethirimol, etem, ethoxyquin, etridiazole, enestroburin, epoxiconazole, oxadixyl, oxycarboxin, copper-8-quinolinolate, oxytetracycline, copper-oxinate, oxpoconazole, oxpoconazole-fumarate, oxolinic acid, octhilinone, ofurace, orysastrobin, carbam (metam-sodium), kasugamycin, carbamorph, carbamorph, carpropamid, carbendazim, carboxin, carboxin, carvone, quinazamid, quinazamid, quinacetol, quinoxyfen, quinomethionate,

captafol, captan, kiralaxyl, quinconazole, quintozene, guazatine, cufraneb, cuprobam, glyodin, griseofulvin, climbazole, cresol, kresoxim-methyl, chlozolinate, chlozolinate, clotrimazole, chlobenthiazone, chloraniformethan, chloranil, chlorquinox, chloropicrin, chlorfenazole, chlorodinitronaphthalene, chlorothalonil, chloroneb, zarilamid, salicylanilide, cyazofamid, diethyl pyrocarbonate, diethofencarb, cyclafuramid, diclocymet, dichlozoline, dichlozoline, diclobutrazol,

dichlofluanid, cycloheximide, diclomezine, dicloran, dichlorophen, dichlone, disulfiram, ditalimfos, dithianon, diniconazole, diniconazole-M, zineb, dinocap, dinocton, dinosulfon, dinoterbon, dinobuton, dinopenton, dipyrithione, diphenylamine, difenoconazole, cyflufenamid, diflumetorim, cyproconazole, cyprodinil, phenylamide compounds such as cyprofuram, cypendazole, simeconazole, dimethirimol, dimethomorph, cymoxanil, dimoxystrobin, methyl bromide, ziram, silthiofam

streptomycin, spiroxamine, sultropen, sedaxane, zoxamide, dazomet, thiadiazin, thiadifluor, thiabendazole, tioxymid, thiochlorfenphim, thiophanate, thiophanate-methyl, thicyofen, thioquinox, chinomethionat, thifluzamide, thiram, decafentin, tecnazene, tecloftalam, tecoram, tetraconazole, debacarb, dehydroacetic acid, tebuconazole, tebufloquin, dodicin, dodine, dodecylbenzenesulphonic acid bisethylenediamine copper [II] salt (DBEDC), dodemorph, drazoxolon,

triadimenol, triadimefon, triazbutil, triazoxide, triamiphos, triarimol, trichlamide, tricyclazole, triticonazole, tridemorph, tributyltin oxide, triflumizole, trifloxystrobin, triforine, tolylfluanid, tolclofos-methyl, natamycin, nabam, nitrothal-isopropyl, nitrostyrene, nuarimol, copper nonylphenol sulfonate, halacrinate,

validamycin, valifenalate, harpin protein, bixafen, picoxystrobin, picobenzamide, bithionol, bitertanol, hydroxyisoxazole, hydroisoxazole-potassium, binapacryl, biphenyl, piperazine (piperalin), hymexazol, pyraoxystrobin, pyracarbolid, pyraclostrobin, pyrazophos, pyrametostrobin, pyriofenone, pyridinitril, pyrifenox, pyribencarb, pyrimethanil, pyroxychlor, pyroxyfur, pyroquilon, vinclozolin, famoxadone, fenapanil, fenamidone, fenaminosulf, fenarimol, fenitropan, fenoxanil,

ferimzone, ferbam, fentin, fenpiclonil, fenpyrazamine, fenbuconazole, fenfuram, fenpropidin, fenpropimorph, fenhexamid, phthalide, buthiobate, butylamine, bupirimate, fuberidazole, blasticidin-S, furametpyr, furalaxyl, fluacrypyrim, fluazinam, fluoxastrobin, fluotrimazole, fluopicolide, fluopyram, fluoroimide, furcarbanil, fluxapyroxad, fluquinconazole, furconazole, furconazole-cis, fludioxonil, flusilazole, flusulfamide, flutianil, flutolanil, flutriafol, furfural, furmecyclox, flumetover, flumorph, proquinazid, prochloraz, procymidone, prothiocarb, prothioconazole, propamocarb,

propiconazole, propineb, furophanate, probenazole, bromuconazole, hexachlorobutadiene, hexaconazole, hexylthiofos, bethoxazin, benalaxyl, benalaxyl-M, benodanil, benomyl, pefurazoate, benquinox, penconazole, benzamorf, pencycuron, benzohydroxamic acid, bentaluron, benthiazole, benthiavalicarb, benthiavalicarb-isopropyl, penthiopyrad, penflufen, boscalid, phosdiphen, fosetyl, fosetyl-Al, polyoxins, polyoxorim, polycarbamate, folpet, formaldehyde, machine oil, maneb, mancozeb,

mandipropamid, myclozolin, myclobutanil, mildiomycin, milneb, mecarbinzid, methasulfocarb, metazoxolon, metam, metam-sodium, metalaxyl, metalaxyl-M, metiram, methyl isothiocyanate, metconazole,

metsulfovax, methfuroxam, metominostrobin, metrafenone, mepanipyrim, mefenoxam, meptyldinocap, mepronil, mebenil, iodomethane, rabenzazole, benzalkonium chloride, basic copper chloride, basic copper sulfate, inorganic fungicides such as silver metal; sodium hypochlorite, cupric hydroxide, wettable sulfur, lime sulfur (calcium polysulfide), potassium hydrogen carbonate, sodium hydrogen carbonate, sulfur, copper sulfate anhydride, an organonickel compound (nickel dimethyldithiocarbamate), zinc sulfates of copper compounds such as an organocopper compound (oxine copper), and copper sulfate pentahydrate salt.

As agricultural and horticultural insecticides, acaricides and nematicides, the following examples can be recited: 3,5-xylyl methylcarbamate (XMC), Bacillus thuringienses aizawai, Bacillus thuringienses israelensis, Bacillus thuringienses japonensis, Bacillus thuringienses kurstaki, Bacillus thuringienses tenebrionis, crystal protein toxins produced by Bacillus thuringienses, BPMC, Bt toxin insecticidal compounds, CPCBS (chlorfenson), DCIP (dichlorodiisopropyl ether), D-D(1,3-dichloropropene), DDT, NAC, O-4-dimethylsulfamoylphenyl O,O-diethyl phosphorothioate (DSP), O-ethyl O-4-nitrophenyl phenylphosphonothioate (EPN), tripropylisocyanurate (TPIC), acrinathrin, azadirachtin, azinphos-methyl, acequinocyl, acetoprole, acephate, abamectin, avermectin-B, amidoflumet, amitraz, alanycarb, aldicarb, aldoxycarb, aldrin, alpha-endosulfan, alpha-cypermethrin, albendazole, allethrin, isazofos, isamidofos, isoamidofos, isoxathion, isofenphos, isoprocarb (MIPC), ivermectin, imicyafos,

imidacloprid, imiprothrin, indoxacarb, esfenvalerate, ethiofencarb, ethion, ethiprole, etoxazole, ethofenprox, ethoprophos, etrimfos, emamectin, emamectin-benzoate, endosulfan, empenthrin, oxamyl, oxydemeton-methyl, oxydeprofos (ESP), oxibendazole, oxfendazole, potassium oleate, sodium oleate, cadusafos, cartap, carbaryl, carbosulfan, carbofuran, gamma-cyhalothrin, xylylcarb, quinalphos, kinoprene, chinomethionat, cadusafos, cloethocarb, clothianidin, clofentezine, chromafenozide, chlorantraniliprole, chlorethoxyfos, chlordimeform, chlordane, chlorpyrifos, chlorpyrifos-methyl, chlorphenapyr, chlorfenson, chlorfenvinphos, chlorfluazuron, chlorobenzilate, chlorobenzoate,

Kelthane (dicofol), salithion, cyanophos (CYAP), diafenthiuron, diamidafos, cyantraniliprole, theta-cypermethrin, dienochlor, cyenopyrafen, dioxabenzofos, diofenolan, sigma-cypermethrin, dichlofenthion (ECP), cycloprothrin, dichlorvos (DDVP), disulfoton, cyhalothrin, cyphenothrin, cyfluthrin, diflubenzuron, cyflumetofen, diflovidazin, cyhexatin, cypermethrin, dimethylvinphos, dimethoate, dimefluthrin, silafluofen, cyromazine, spinetoram, spinosad, spirodiclofen, spirotetramat, spiromesifen, sulfluramid, sulprofos, sulfoxaflor, zeta-cypermethrin, diazinon

tau-fluvalinate, dazomet, thiacloprid, thiodicarb, thiocyclam, thiosultap, thiosultap-sodium, thionazin, thiometon, deet, dieldrin, tetrachlorvinphos, tetradifon, tetramethylfluthrin, tetramethrin, tebupirimfos, tebufenozide, tebufenpyrad, tefluthrin, teflubenzuron, demeton-S-methyl, temephos, deltamethrin, terbufos, tralopyril, tralomethrin, transfluthrin, triazamate, triazuron, trichlamide, trichlorphon (DEP), triflumuron, tolfenpyrad, naled (BRP), nithiazine, novaluron, noviflumuron, hydroprene, vaniliprole, vamidothion, parathion, parathion-methyl, halfenprox, halofenozide,

bistrifluron, bisultap, hydramethylnon, hydroxy propyl starch, binapacryl, bifenazate, bifenthrin, pymetrozine, pyraclorfos, pyrafluprole, pyridafenthion, pyridaben, pyridalyl, pyrifluquinazon, pyriprole, pyriproxyfen, pirimicarb, pyrimidifen, pirimiphos-methyl, pyrethrins, fipronil, fenazaquin, fenamiphos, bromopropylate, phenisobromolate, fenitrothion (MEP), fenoxycarb, fenothiocarb, phenothrin, fenobucarb, fensulfothion, fenthion (MPP), phenthoate (PAP), fenvalerate, fenpyroximate, fenpropathrin, fenbendazole, fosthiazate, formetanate, butathiofos, buprofezin, furathiocarb, prallethrin, fluacrypyrim, fluazinam, fluazuron,

fluensulfone, flucycloxuron, flucythrinate, fluvalinate, flupyrazofos, flufenerim, flufenoxuron, flufenzine, flufenoprox, fluproxyfen, flubrocythrinate, flubendiamide, flumethrin, flurimfen, prothiofos, protrifenbute, protrifenbute, flonicamid, propaphos, propargite (BPPS), profenofos, profluthrin, propoxur (PHC), bromopropylate, beta-cyfluthrin, hexaflumuron, hexythiazox, heptenophos, permethrin, benclothiaz, bendiocarb, bensultap, benzoximate, benfuracarb, phoxim, phosalone, fosthiazate, fosthietan, phosphamidon, phosphocarb, phosmet (PMP), polynactin complexes (polynactins), formetanate, formothion, phorate, machine oil,

malathion, milbemycin, milbemycin-A, milbemectin, mecarbam, mesulfenfos, methomyl, metaldehyde, metaflumizone, methamidophos, metam-ammonium, metam-sodium, methiocarb, methidathion (DMTP), methylisothiocyanate, methylneodecanamide, methylparathion, metoxadiazone, methoxychlor, methoxyfenozide, metofluthrin, methoprene, metolcarb, meperfluthrin, mevinphos, monocrotophos, monosultap, lambda-cyhalothrin, ryanodine, lufenuron, resmethrin, lepimectin, rotenone, levamisole hydrochloride, fenbutatin oxide, morantel tartarate, methyl bromide, tricyclohexyltin hydroxide (cyhexatin), calcium cyanamide, lime sulfur (calcium polysulfide), sulfur and nicotine-sulfate.

As synergists, the following examples can be recited: piperonyl butoxide), sesame, sulfoxide), N-(2-ethylhexyl)-8,9,10-trinorborn-5-en-2,3-dicarboxyimide (MGK 264), N-declyimidazole, WARF-antiresistant) TBPT, TPP, IBP, PSCP, methyl iodide, t-phenylbutenone, diethylmaleate), DMC, FDMC, ETP and ETN and the like.

As safeners, the following examples can be recited: benoxacor, cloquintocet-mexyl, cyometrinil, daimuron), dichlormid), cyprosulfamide), fenchlorazole-ethyl, fenclorim), flurazole), fluxofenim, furilazole, mefenpyr-diethyl, MG191, oxabetrinil, allidochlor, isoxadifen-ethyl, cyprosulfamide, fluxofenim and 1,8-naphthalic anhydride) and the like.

Furthermore, a combination of tiadinil or a salt thereof and chlorothalonil, which is hereinafter referred also to as the present inventive combination, consititutes the present invention. The present inventive combination can be termed, in other words, as a controlling agent against plant disease consisting of tiadinil or a salt thereof and chlorothalonil. In the present inventive combination, the active ingredients of the present inventive agricultural and horticultural fungicidal composition, tiadinil or a salt thereof and chlorothalonil, can achieve, by each alone being used separately around the same period, expansion of the fungicidal spectrum equivalent to that of an agricultural and horticultural fungicidal composition in which the active ingredients have been mixed in advance, or a synergistic effect achieved by tiadinil or a salt thereof and chlorothalonil. Namely, formulations of tiadinil or a salt thereof and chlorothalonil, which formulations have separately been prepared, or a diluted solution thereof, may be blended on the site where they are used for the application; furthermore, these formulations can be used around the same period for treating foliage or seeds of plants or cultivation carriers and the like for the treating. When each alone is applied separately at different times, the active ingredients may be applied simultaneously or with an interval of about seven days. In the case where each alone is applied separately, tiadinil or a salt thereof may be applied and then chlorothalonil thereafter, or chlorothalonil may be applied before tiadinil or a salt thereof is applied thereafter. Preference is given for a case where, during the time when either one of the active ingredients is remaining on the plants or cultivation carriers, the other active ingredient is applied. Effective amounts of tiadinil or a salt thereof and chlorothalonil or manufacturing methods in the present inventive combination are equivalent to those above recited for the agricultural and horticultural fungicidal composition. In the present inventive combination, the above-described agricultural and horticultural fungicidal agent, an insecticide, acaricide, nematicide, biological agrochemical or other known additives and the like may further be combined. The present inventive combination is preferably used for controlling plant diseases.

Then the present invention is specifically explained by citing examples; the present invention is not limited to which examples as long as it does not go beyond the gist of the invention. In the following examples, the wording “%” represents “mass %” unless otherwise stated.

### Examples

In the following cited are representative formulation examples of the present invention, the present invention is not limited to which formulation examples.

In the formulation examples, the wording “part(s)” represents “part(s) by mass”.

### Formulation Example 1

| | |
|---|---|
| Tiadinil | 2 parts |
| Chlorothalonil | 4 parts |
| Xylene | 74 parts |
| N-Methylpyrrolidone | 10 parts |
| A mixture of polyoxyethylene nonylphenyl | 10 parts |
| ether and calcium alkylbenzenesulfonate | |

The above-described ingredients are uniformly mixed and dissolved to form an emulsifiable concentrate.

### Formulation Example 2

| | |
|---|---|
| Tiadinil | 0.1 parts |
| Chlorothalonil | 2 parts |
| Clay powder | 82.9 parts |
| Diatomaceous earth powder | 15 parts |

The above-described ingredients are uniformly blended and finely crushed to form a dust.

### Formulation Example 3

| | |
|---|---|
| Tiadinil | 2 parts |
| Chlorothalonil | 4 parts |
| A powder mixture of bentonite and clay | 89 parts |
| (Mixing ratio of bentonite:clay = 30:70 (mass ratio)) | |
| Calcium ligininsulfonate | 5 parts |

The above-described ingredients are uniformly blended added with water, kneaded, granulated and dried to for a granule.

### Formulation Example 4

| | |
|---|---|
| Tiadinil | 1 parts |
| Chlorothalonil | 20 parts |
| Kaolin and synthetic, finely dispersed silicic acid | 74 parts |
| (Mixing ratio of kaolin:synthetic, finely dispersed | |
| silicic acid = 85:15 (mass ratio)) | |

The above-described ingredients are uniformly blended and finely crushed to form a wettable powder.

### Formulation Example 5

| | |
|---|---|
| Tiadinil | 0.5 parts |
| Chlorothalonil | 10 parts |
| Lunox 1000C (trade name, product of Toho | 5 parts |
| Chemical Industry Co., Ltd.) | |
| Carplex #80D (trade name, product of | 3 parts |
| Evonik Japan Co., Ltd.) | |
| Ethylene glycol | 8 parts |
| Water | 53.5 parts |

The above-described ingredients are mixed and dispersed, the slurry mixture obtained was wet pulverize with DYNO-MILL (trade name, product of WAB), 1% aqueous solution of gum xanthan, which was in advance mixed and dissolved, in 20 parts are added and uniformly mixed, to form an aqueous suspension concentrate (flowable) containing 10.5% of the active ingredients.

Test Example below shows that the present inventive agricultural and horticultural fungicidal composition achieves, compared with the case where each one of the active ingredients is used alone, a remarkable efficacy.

### Test Example 1

With a hand spray, chemical agents (no spreader added) prepared from commercial formulations at the predetermined concentrations were sprayed with the volume of 0.25 l/m². Seven days after the final spraying, with a hole cutter (10 cm in diameter), two sods were cut out, transferred into a greenhouse and inoculated with Pythium aphanidermatum.

For the test plot for the present invention, chemical solutions of tiadinil and chlorothalonil were each prepared, and each of the chemical solutions were blended for use as compositions and combinations.

Seven days after the inoculation, lesion diameters in each treated plots and the untreated plot were measured for calculating the control values for each treated plots using an equation below.

$$Control value ( \% ) = \frac{( \begin{matrix}lesion diamter of untreated plot - \\ lesion diameter of treated plot\end{matrix} ) \times 100}{lesion diamter of untreated plot}$$

In addition, based on a Colby's expectation value calculated using the Colby's equation below, a synergistic effect was investigated. In general, in a case, where two active ingredients given are mixed and treated, if the actual efficacy measured is larger than the Colby's expectation value (E) calculated using the Colby's equation below, wherein value (E) is interpreted to denote an expected control value (%) which is predicted by the combination of the two active ingredients, the function achieved by the combination of the two active ingredients is determined to be synergistic.

$$Colby ’ s Expection Value ( E ) = ( X + Y ) \cdot \frac{( X \times Y )}{100}$$

(wherein X represents the preventive value (%) of one of the active ingredients and Y represents the preventive value (%) of the other active ingredient.)

The result is shown in TABLE 1.

TABLE 1

| | Dose | Control | Colby's |
|---|---|---|---|
| | (fl oz/ | Value | Expectation |
| | 1,000 ft²) | (%) | Value (E) |
| Tiadinil + | 1.25 + 1.1 | 56 | 40 |
| Chlorothalonil | 0.625 + 1.1 | 56 | 40 |
| | 0.3125 + 1.1 | 61 | 31 |
| | 0.15625 + 1.1 | 56 | 31 |
| Tiadinil | 1.25 | 22 | — |
| | 0.625 | 22 | — |
| | 0.3125 | 11 | — |
| | 0.15625 | 11 | — |
| Chlorothalonil | 1.1 | 22 | — |

As is clearly understood from the results recited in TABLE 1, tiadinil or chlorothalonil, when treated each alone, did not show sufficient efficacy against Pythium aphanidermatum, whereas the combined use of tiadinil and chlorothalonil showed an effect over the expected value (E), i.e. a synergistic effect and thus an excellent controlling effect.

### INDUSTRIAL APPLICABILITY

The present inventive agricultural and horticultural fungicidal composition achieves a low global environmental impact, has a wide fungicidal spectrum against various plant diseases and an excellent controlling efficacy at low doses, being useful because of these features.

1. An agricultural and horticultural fungicidal composition comprising tiadinil or a salt thereof and chlorothalonil as active ingredients.

2. The agricultural and horticultural fungicidal composition according to claim 1, wherein the composition contains, to one part by mass tiadinil or a salt thereof, 0.5 to 1000 parts by mass of chlorothalonil.

3. A method of use of the agricultural and horticultural fungicidal composition, wherein, using an effective amount of the agricultural and horticultural fungicidal composition according to claim 1, a target plant, seeds of a target plant, soil or a cultivation carrier is treated and a plant disease is controlled.

4. A method of controlling a plant disease, wherein each of tiadinil and chlorothalonil are treated separately on a plant or cultivation carrier around the same period and the plant disease is controlled.

5. A combination of tiadinil or a salt thereof and chlorothalonil.

6. The method of controlling a plant disease according to claim 4, wherein the plant disease is a lawn grass disease.

7. The method of controlling a plant disease according to claim 6, wherein the lawn grass disease is Pythium aphanidermatum.
